(19) United States
(12) Patent Application Publication
(10) Pub. No.: US 2009/0044369 A1
(43) Pub. Date: Feb. 19, 2009

(54) Cylindrical member maintenance device including cutting ring

(76) Inventors: Steven A. Heumann, Windsor, CA (US); Richard D. Howard, Windsor, CA (US)

Correspondence Address: DERGOSITS & NOAH LLP, FOUR EMBARCADERO CENTER, SUITE 1450, SAN FRANCISCO, CA, 94111, US

(21) Appl. No.: 11/893,822

(22) Filed: Aug. 16, 2007

(51) Int. Cl. B08B 1/04; B66B 7/12

(52) U.S. Cl. 15/302; 15/256.6

(57) ABSTRACT

The present invention provides a cylindrical member maintenance device that includes housing having a central opening for the passage of the cylindrical member and one or more cutting rings disposed within the housing for engaging the cylindrical member as the housing is moved along a length of the cylindrical member. The device may further include or more brush assemblies disposed within the housing for engaging and cleaning the cylindrical member.

### TECHNICAL FIELD

The invention broadly relates to devices for cleaning structural cables and other cylindrical members, and more particularly to a cylindrical member maintenance device including a cutting ring for removing hard to reach paint and other debris from within grooves of the cylindrical member.

### BACKGROUND OF THE INVENTION

A braided steel cable, such as the type used on suspension bridges, is comprised of a plurality of braided strands helically wrapped around a solid core. The cable is made of steel and thus requires periodic maintenance to prevent rusting. Typical maintenance comprises removing surface dirt, rust, and old paint, then painting the cleaned surface.

A conventional cleaning device for cleaning braided steel cables is comprised of a housing which positions wire brushes around a cable. When the cleaning device is moved along the cable, the cable is cleaned by the wire brushes. Some cleaning devices also apply a cleaning fluid. Prior art cable cleaners can clean the lands of the cable, that is, the outermost parts of the strands, but cannot clean deep inside the grooves between adjacent strands. Also, the wire brushes wear out quickly. Further, debris and cleaning fluids fly out from the cleaning device as environmental contaminants.

### SUMMARY OF THE INVENTION

The present invention is related to U.S. Pat. No. 6,990,707, the disclosure of which is incorporated by reference herein. It provides for a cylindrical member maintenance device for cleaning and/or painting a cylindrical member, such as a braided steel cable. Such a cleaning may involve: (1) applying a cleaning fluid to the cylindrical member to loosen up debris such as dirt and paint chips; (2) scraping out valleys (grooves) of the cylindrical member to remove stubborn debris from the valleys and/or (3) scrubbing the cylindrical member using a plurality of helical and/or longitudinal brushes. After thoroughly cleaning the lands and grooves of the cylindrical member, it may be automatically painted using the cylindrical member maintenance device. A vacuum system may be employed to avoid releasing debris, cleaning fluid, and/or paint into the environment.

As noted in the '707 patent, the cylindrical member maintenance device may comprise a housing including two hinged halves for being closed around a cylindrical member, such as a braided steel cable. Centering rings in the housing fit closely around the cylindrical member to center the housing and to seal the interior from the outside environment. A rotary helical brush assembly and a rotary longitudinal brush assembly are positioned in the housing and rotatable about an axis of the housing. The rotary helical brush assembly is comprised of coaxial rings with cylindrical wire brushes connected in between in a helical arrangement. The rotary longitudinal brush assembly is comprised of coaxial rings with cylindrical wire brushes connected in between in a longitudinal arrangement.

The brushes of both the rotary helical brush assembly and the rotary longitudinal brush assembly are independently rotatable about their own axes. Nozzles are positioned on the inside of the housing for applying a cleaning fluid or paint to the cylindrical member. Apertures in the housing are for connecting to a suction device for removing debris, cleaning fluid, and paint to avoid contaminating the environment. Connectors on the housing are for attaching to cables for moving the housing along the cylindrical member.

The present invention expands over the disclosure presented in the '707 patent in providing at least one cutter ring for engaging the cylindrical member in addition to the brushes and other structure disclosed previously. Although the cutter rings can be enclosed within their own housing, as depicted in FIG. 13, according to a preferred embodiment of the present invention, they can be included with the brush assemblies, alone, or with various application and evacuation assemblies as a complete, stand alone maintenance device. For example, the device may comprise a single brush assembly sandwiched by a pair of cutters rings, wherein each cutter ring is independently rotatable around the cylindrical member, and wherein the brush assembly may comprise a longitudinal brush assembly or a helical brush assembly.

According to an aspect of the invention, the cutter ring comprises a split ring and a pair of wear bearings that sandwich the split ring therebetween, wherein the wear bearings allow a first cutter ring to rub against a second cutter ring (or brush assembly) with minimal friction between the bearings. One suitable material for the bearings is high-density polyethylene (HDPE).

According to another aspect of the invention, the cutter ring comprises a plurality of cutters that protrude into a central opening of the cutter ring for engaging the grooves of the cylindrical member, and the cutters are disposed at various angles around the circumference of the cutter ring. The cutters may comprise cutter pin angles having a threaded proximal portion for engaging a correspondingly threaded portion of through holes within the cutter ring, and a tapered distal end that protrudes inwardly into the central opening. In a preferred implementation, the cutter ring comprises six cutters and each cutter is separated from two other cutters by approximately 60°, as measured from a midpoint of the central opening.

According to a further aspect of the invention, the housing includes one or more apertures for connection to a suction device for safely removing contaminants without harming the environment, wherein the suction device is attached to the housing such that it travels with the housing during operation. The device may further comprise a distribution chamber and an air hose forming a conduit between the aperture and the suction device for the removal of paint chips, waste fluid, dirt, dust and other debris from the housing. The amount of negative pressure created in the housing by suction device is greatly enhanced because the suction device travels with the housing instead of being located on the ground. Additionally, the suction device substantially prevents the housing from spinning about the cylindrical member when it is attached thereto.

According to an additional aspect of the invention, the cylindrical member maintenance device further comprises a pouch attached to a bottom of the housing for catching particles that fall through the bottom of the housing that would otherwise be released into the environment as potential contaminants. The pouch is preferably detachable from the housing such that collected particles may be properly disposed of in an environmentally sensitive manner. In a preferred implementation, the pouch comprises a flexible outer bag and an inner tube that is adapted to slide along the perimeter of the cylindrical member as the device is moved along a length of the cylindrical member during normal operation. A suitable material for the inner tube is HDPE.

These and other features and advantages of the present invention will be appreciated from review of the following detailed description of the invention, along with the accompanying figures in which like reference numerals refer to like parts throughout.

### BRIEF DESCRIPTION OF THE FIGURES

FIG. 1 is a perspective view of a cylindrical member maintenance device in an opened configuration in accordance with the principles of the invention;

FIG. 2 is a perspective view of the cylindrical member maintenance device of FIG. 1 in a closed configuration;

FIG. 3 is a sectional view of the cylindrical member maintenance device of FIG. 2 taken along line 3-3;

FIG. 4 is a sectional view of the cylindrical member maintenance device of FIG. 2 taken along line 4-4;

FIG. 5 is a perspective view of the rotary helical brush assembly of FIG. 1 in a disassembled state;

FIG. 6 is a perspective view of an alternative embodiment of the cylindrical member maintenance device of FIG. 1;

FIG. 7 is a top view of a preferred valley cutter in accordance with the principles of the present invention;

FIG. 8 is a side view of the valley cutter of FIG. 7, wherein the cutters have been removed;

FIG. 9 is a sectional view of the valley cutter of FIG. 8 taken along line 9-9;

FIG. 10 is a perspective view of a preferred cylindrical member maintenance device in an opened configuration in accordance with the principles of the invention;

FIG. 11a is a perspective view of the cylindrical member maintenance device of FIG. 10 in a closed configuration, and including a suction device attached to the housing;

FIG. 11b is a side view of a rigging system for indirectly attaching the suction device to the housing of FIG. 11a; and

FIG. 12 is a perspective view of a pouch that is releasably attached to the cylindrical member maintenance device of FIG. 11a or 11b.

FIG. 13 is a side perspective view of an alternative embodiment in which the cutter ring is contained within its own stand-alone housing.

### DETAILED DESCRIPTION OF THE INVENTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

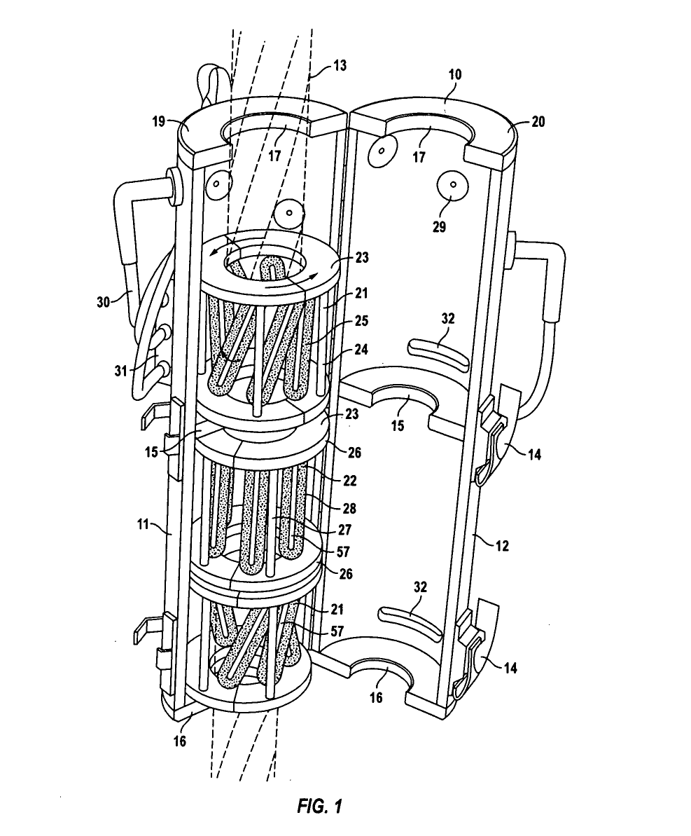

Referring to FIG. 1, a cylindrical member maintenance device is shown in a perspective view in an opened position. It is comprised of a housing 10 comprised of two hinged half housings 11 and 12 for closing around a cylindrical member 13, such as a braided steel cable. This device was disclosed in the referenced '707 patent. The cleaner can be used for cleaning other types of cylindrical members, such as pipes. Half housings 11 and 12 are locked together by latches 14 after they are closed around cylindrical member 13.

Split alignment rings 15 and 16 in housing 10 align cylindrical member 13 therein and seal the interior of housing 10 from the outside environment. A split sealing ring 17 is positioned at a first end of housing 10. Sealing ring 17 has a slightly larger inner diameter than those of alignment rings 15 and 16 to avoid touching cylindrical member 13. Rings 15-17 are each comprised of two half rings 19 and 20 attached to respective half housings 11 and 12, so that rings 15-17 can be opened and closed around cylindrical member 13.

Rotary helical brush assemblies 21 and a rotary longitudinal brush assembly 22 are positioned in housing 10 and rotatable about an axis thereof. There may be any number of each type of brush assembly. Rotary helical brush assembly 21 is comprised of coaxial split rings 23 connected by spacers 24 and rotary cylindrical wire brushes 25 in a helical arrangement. Rotary longitudinal brush assembly 22 is comprised of coaxial split rings 26 connected by spacers 27 and cylindrical wire brushes 28 in a longitudinal arrangement. The brushes in either brush assembly are independently rotatable about their own axle 57. Each brush assembly can be opened and closed around cylindrical member 13.

Nozzles 29 are positioned inside housing 10 in a space between brush assembly 21 and sealing ring 17 for applying a fluid to cylindrical member 13. Nozzles 29 are connected by hoses 30 to a distribution chamber 31 attached to the outside of housing 10. Suction apertures 32 in housing 10 are for connecting to a suction device (not shown) for removing debris and waste fluid from inside housing 10 to avoid contaminating the outside environment.

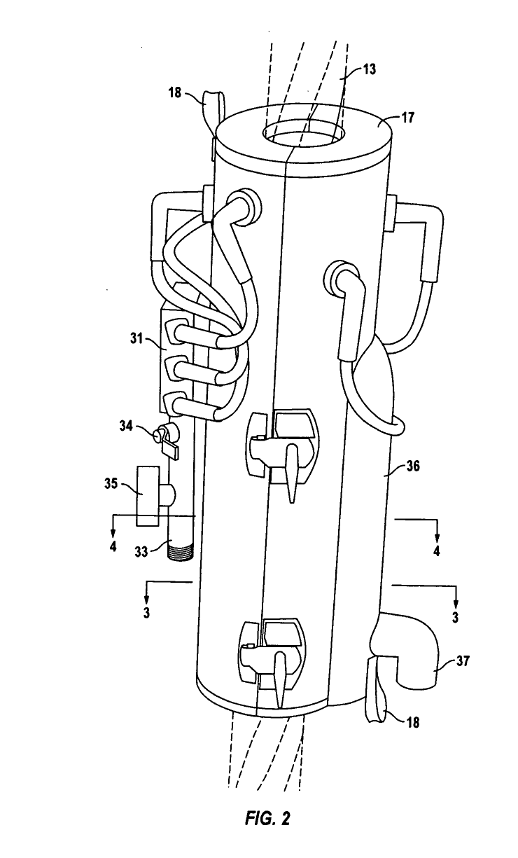

Referring to FIG. 2, the cylindrical member maintenance device is shown in a closed position around cylindrical member 13. A connector 33 extending from chamber 31 is arranged for connecting to a pressurized source of fluid (not shown), such as a cleaning fluid or paint. A valve 34 and a pressure gauge 35 are also connected to chamber 31. When the fluid is sprayed onto cylindrical member 13 by nozzles 29 (FIG. 1), it is contained within housing 10 to avoid contaminating the outside environment.

A suction distribution chamber 36 is connected to suction apertures 29 (FIG. 1). A connector 37 on chamber 36 is for connecting to a suction device (not shown). Loops 18 on housing 10 are for attaching to cables (not shown) for moving housing 10 along cylindrical member 13. Loops 18 are positioned on opposite sides of housing 10 to prevent housing 10 from rotating about cylindrical member 13.

When the cylindrical member maintenance device is used for cleaning the steel cable, it may be moved in an upward direction along the steel cable. When the cylindrical member maintenance device is used for painting the steel cable, it may be moved in a downward direction along the steel cable. The painted portion will only travel past sealing ring 17, which has a slightly larger hole than alignment rings 15 and 16 (FIG. 1) to avoid touching the freshly painted portion of the steel cable.

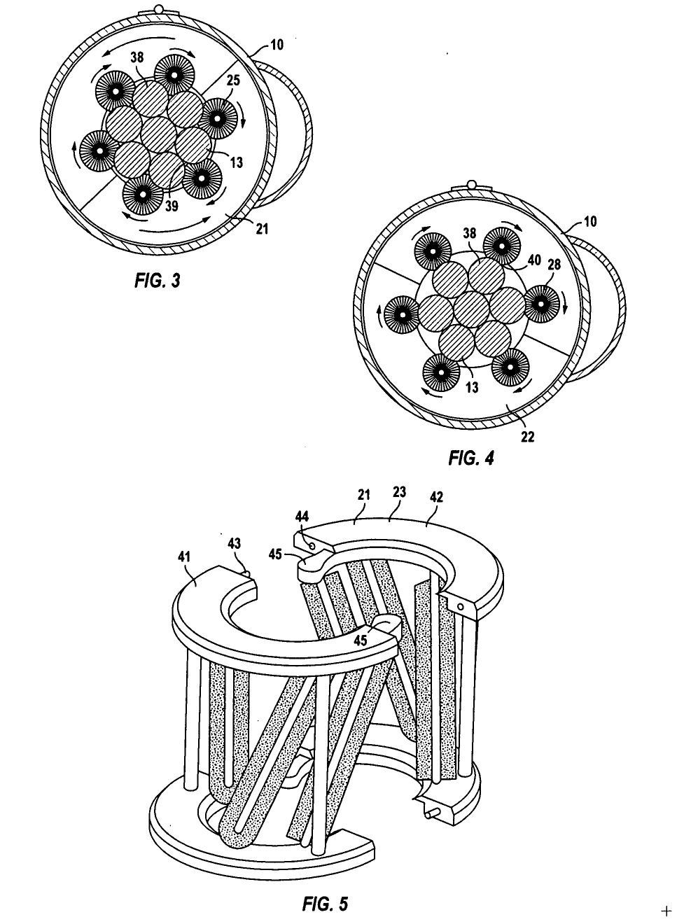

Referring to FIG. 3, a sectional view of rotary helical brush assembly 21 is shown positioned around a cylindrical member 13 which in this example is comprised of a braided steel cable with helical strands 38. The number of cylindrical brushes 25 is selected to match the number of strands 38 in the steel cable. Cylindrical brushes 25 are canted (see FIG. 1) to align with helical grooves 39 between helical strands 38 of the steel cable for cleaning grooves 39.

As housing 10 is moved along the steel cable, brush assembly 21 is rotated about the axis of the steel cable as brushes 25 are guided along helical grooves 39. The friction with grooves 39 cause cylindrical brushes 25 to rotate about their own axes independently of each other in a direction opposite the rotation of brush assembly 21 for better cleaning. The rotation of brushes 25 about their own axes also enable to them wear longer because individual bristles are in contact with the steel cable only some of the time.

Referring to FIG. 4, a sectional view of rotary longitudinal brush assembly 22 is shown positioned around the steel cable. Cylindrical brushes 28 are aligned with the axis of the steel cable, and are positioned to engage raised portions or lands 40 of strands in the steel cable. Brushes 28 are caused by helical strands 38 to rotate about their own axes.

Referring to FIG. 5, rotary helical brush assembly 21 is shown split apart. Split rings 23 are each separable into two halves 41 and 42, and include pins 43 and holes 44 at abutting surfaces for mating with each other. Split rings 23 also include projections 45 extending from the abutting surfaces for attaching canted cylindrical brushes 25 that extend beyond the abutting surfaces.

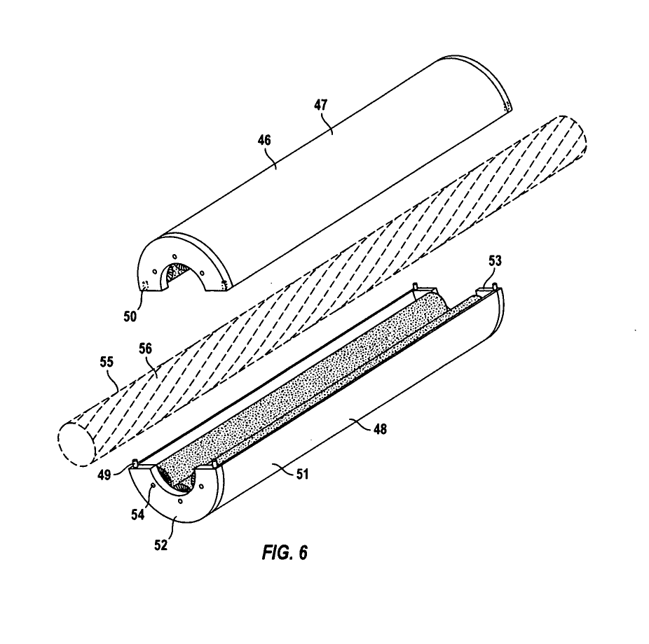

Referring to FIG. 6, a second embodiment of the cylindrical member maintenance device is shown comprising a housing 46 including two separable halves 47 and 48 connected by pins 49 and holes 50. Longitudinal rotary cylindrical brushes 51 are positioned inside housing 46 between split rings 52 and 53 at opposite ends of housing 46. Brushes 51 are independently rotatable about their own axle 54. Housing 46 is split apart and closed around a cylindrical member 55, such as a stranded steel cable. Brushes 51 are positioned to engage the steel cable. When housing 46 is moved along the steel cable, brushes 51 are rotated by helical strands 56 of the steel cable.

Braided steel cables 13, such as depicted in cross-section in FIG. 4, include a plurality of grooves 39 that are difficult to clean using conventional scraping and cleaning equipment. According to an aspect of the present invention, ring-shaped cutters are provided including projections that are adapted to scrape hard to reach paint, dirt and other debris from within the grooves between the helical strands of the steel cable.

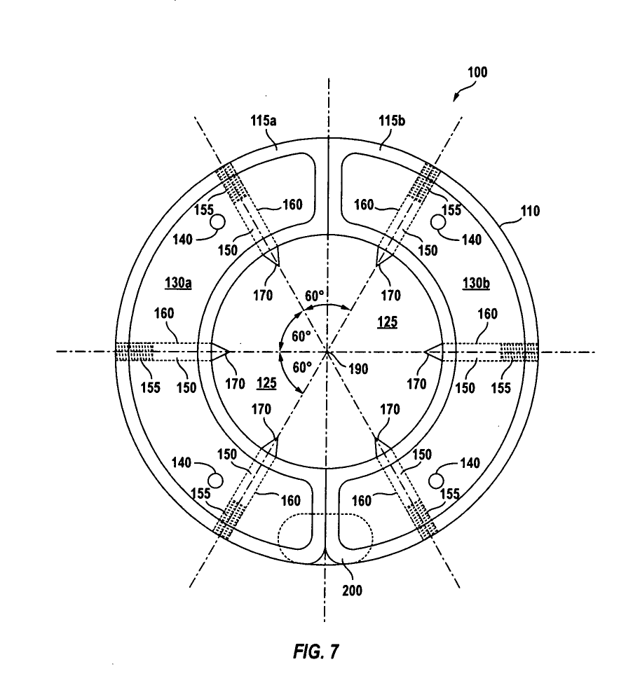

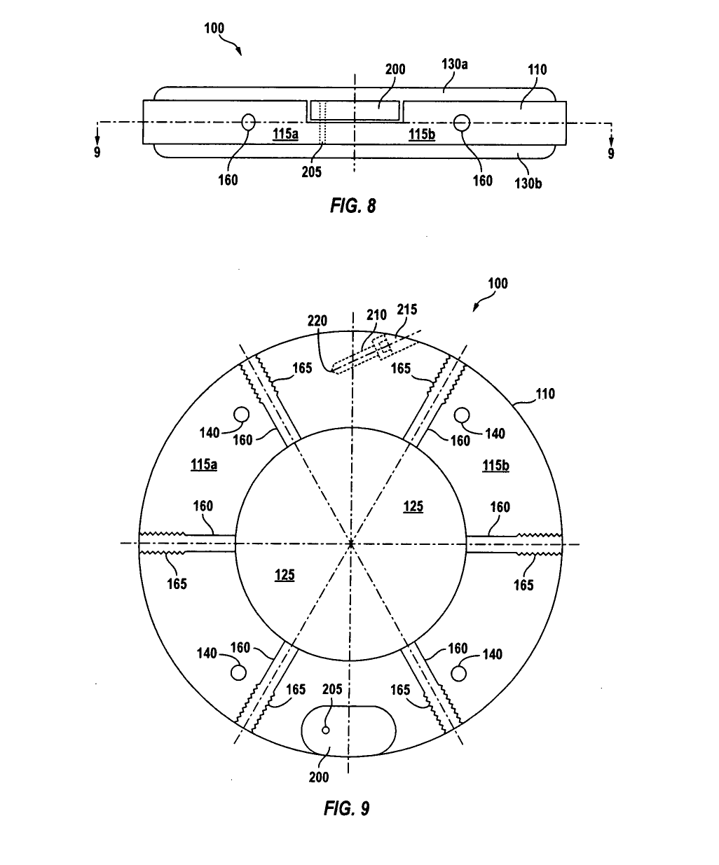

Referring to FIGS. 7-9, a preferred cutter ring 100 of the present invention comprises cutter body 110 including split ring halfs 115a and 115b and a pair of substantially flat wear bearings 130a, 130b that sandwich the valley cutter body 110 therebetween. When cutter 100 is in a closed configuration, it forms a concentric ring having a central opening 125 dimensioned for the passage of a cylindrical member such as a braided steel cable. A plurality of apertures 140 in body 110 and bearings 130a, 130b are provided to receive fasteners for fixedly attaching the bearings 130a, 130b to cutter body 110. Bearings 130a, 130b are designed to allow a cutter to rub against its housing, another cutter or brush assembly with minimal friction between the bearings. High-density polyethylene (HDPE) is the preferred material for the bearings 130a, 130b, although other materials such as polyvinyl chloride (PVC) may be employed without departing from the scope of the invention.

With further reference to FIGS. 7-9, a plurality of cutting elements 150 are disposed within through holes 160 at various angles around the circumference of valley cutter 100. In the illustrated embodiment, cutting elements 150 comprise cutter pins each having a threaded proximal portion 155 for engaging correspondingly threaded portion 165 of through holes 160, and a tapered distal end 170 that protrudes inwardly into central opening 125. Cutting elements 150 may alternatively comprise teeth, blades or other projections having a tapered or non-tapered distal end suitable for cleaning the grooves of a cylindrical member such as a braided steel cable. During use, tapered distal ends 170 of cutting elements 150 are used to remove paint, dirt and other debris from within the grooves between the helical strands of the steel cable. Cutting elements 150 can be composed of, for example, pointed brass rails having sufficient hardness to resist excessive wear while not unduly eroding the braided cable.

As depicted in FIG. 4, a typical braided steel cable 13 includes six grooves 39, and therefore the preferred cutter 100 of the invention comprises six cutting elements 150 (one for each groove) disposed within cutter body 110. Specifically, each cutting element 150 is separated from two other cutting elements 150 by approximately 60° (360°/6), as measured from a midpoint 190 of central opening 125. Other known steel cables include a different number of grooves, such as twelve grooves or seven grooves. For a braided steel cable having twelve grooves, the cutter may be adapted to feature twelve cutting elements 150, wherein each cutting element 150 is separated from two other cutting elements 150 by approximately 30° (360°/12), as measured from midpoint 190. For a braided steel cable having seven grooves, the cutter may be adapted to feature seven cutting elements 150, wherein each cutting element 150 is separated from two other cutting elements 150 by approximately 51.4° (360°/7), as measured from midpoint 190. As would be appreciated by those of ordinary skill in the art, any other number of cutting elements may be employed without departing from the scope of the present invention.

With further reference to FIGS. 7-9, split ring 115a/115b comprises a pair of half rings that are hingedly attached at one end via hinge 200 having fastener 205 that forms an axis of rotation. Hinged half rings 115a, 115b are releasably attached at a substantially opposite end via threaded fastener 210. In particular, threaded fastener 210 passes through aperture 215 in hinged half 115b and into aperture 220 in hinged half 115a such that valley cutter 100 may be removed for maintenance or replacement. Alternatively, or in addition to threaded fastener 210, the hinged halves 115a, 115b may be held together using a removable pin, a clasp and/or spring clips.

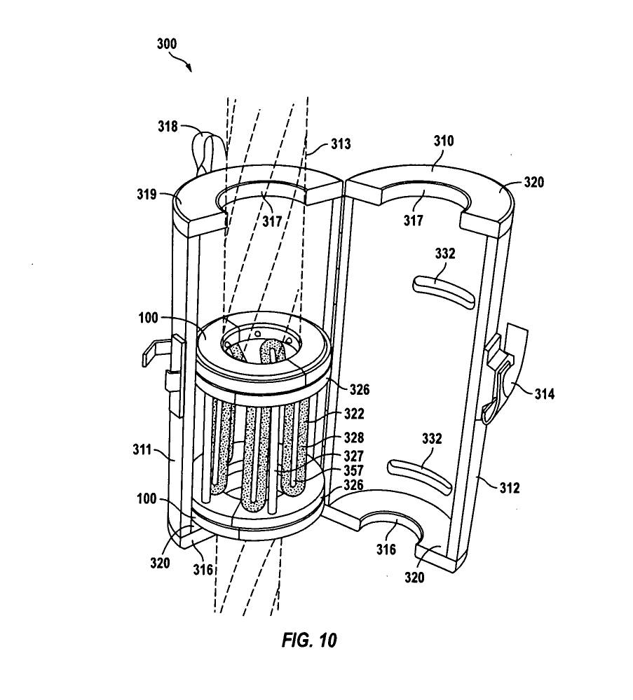

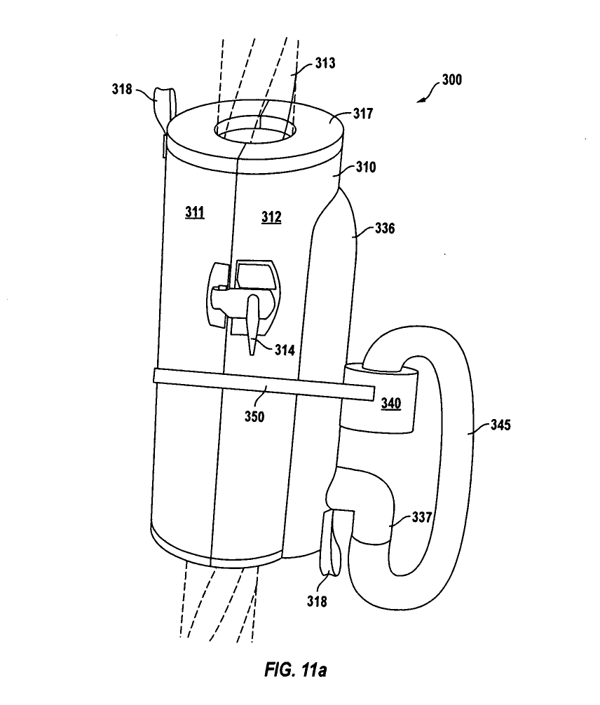

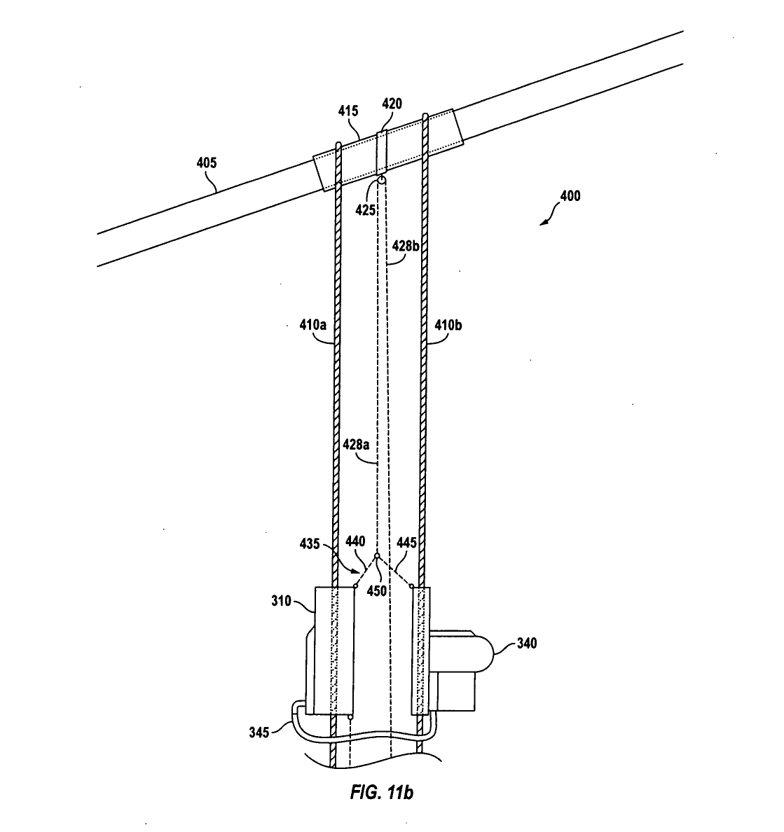

Referring to FIG. 10, a preferred cylindrical member maintenance device 300 of the present invention is shown in a perspective view in an opened position. Cylindrical member maintenance device 300 comprises a housing 310 including two hinged half housings 311, 312 for closing around a cylindrical member 313, such as a braided steel cable. Half housings 311, 312 are locked together by one or more latches 314 after they are closed around cylindrical member 313. Cylindrical member maintenance device 300 further comprises one or more suction apertures 332 for connection with a suction device 340 (see FIG. 11) for removing debris and waste fluid from inside housing 310 to avoid contaminating the outside environment.

Cylindrical member maintenance device 300 also includes a split alignment ring 316 located at the bottom of housing 310 and a split sealing ring 317 located at the top of housing 310. Rings 316, 317 help align cylindrical member 313 and seal the interior of housing 310 from the outside environment. Each ring 316, 317 comprises two half rings 319, 320 attached to respective half housings 311, 312, such that rings 316, 317 can be opened and closed around cylindrical member 313. Loops 318 are connected to housing 310 for attachment to cables (not shown) for moving housing 310 along cylindrical member 313. According to some embodiments, loops 318 may be positioned on opposite sides of housing 310 to prevent housing 310 from rotating about cylindrical member 313 during operation.

In the preferred embodiment illustrated in FIG. 10, a pair of cutters 100 and a brush assembly 322 are disposed within housing 310, such that brush assembly is sandwiched between cutters 100. During use, the housing is moved along the length of cylindrical member 313 such that cutters 100 scrape hard to reach paint, dirt and other debris from the grooves of cylindrical member 313. At the same time, brush assembly 322 removes additional amounts of paint and waste material for a more thorough cleaning of the cylindrical member. Each cutter 100 preferably is independently rotatable around the cylindrical member 313.

As noted previously, cutter 100 need not be placed in an assembly of other component parts, such as shown in FIG. 10, but could be housed in its own assembly. In this regard, reference is made to FIG. 13 whereby cutter 100 is shown housed within housing 510 capable of traveling along cylindrical member 520 as shown. Assembly 500 can be used above or below other cylindrical member maintenance devices of the type described above, proceeding or following along such assemblies as they proceed along various cylindrical members for cleaning, or the like. The debris vacuum assemblies and debris catchers such as those described herein can be employed in conjunction with housing 510, although, for the sake of simplicity, such add-on components have not been included in the apparatus shown in FIG. 13.

Returning to FIG. 10, although brush assembly 322 is depicted as a longitudinal brush assembly 22 (see FIG. 1), it is understood that other brush assemblies such as a helical brush assembly 21 (see FIG. 1) may be employed without departing from the scope of the invention. Additionally, cylindrical member maintenance device 300 may feature more than one brush assembly or no brush assembly at all. Moreover, maintenance device 300 is not limited to the use of two cutters 100 in that any number of cutters 100 may be disposed within housing 310 without departing from the scope of the invention. As described above with respect to FIG. 1, rotary longitudinal brush assembly 322 comprises coaxial split rings 326 connected by spacers 327 and cylindrical wire brushes 328 in a longitudinal arrangement. The brushes in either brush assembly are independently rotatable about their own axis 357. Each brush assembly can be opened and closed around cylindrical member 313.

Referring to FIG. 11a, cylindrical member maintenance device 300 is shown in a closed position around cylindrical member 313. Distribution chamber 336, connector and air hose 345 form a conduit for connecting suction apertures 332 to a suction device 340 such as a conventional vacuum cleaner. In particular, suction device 340 is employed to remove paint chips, waste fluid, dirt, dust and other debris through suction apertures 332, into distribution chamber 336, through connector 337 and air hose 345, and into suction device 340. The use of suction device 340 beneficially reduces the amount of pollutants that are released during cleaning of the cylindrical member, thereby decreasing the amount of environmental contamination.

In the embodiment of FIG. 11a, the suction device 340 is releasably attached to the housing 310 (e.g., via straps 350) such that it travels with the housing 310 during use. Advantageously, the amount of negative pressure created in housing 310 by suction device 340 is greatly enhanced when suction device 340 travels with housing 310, as opposed to being located on the ground. This phenomenon is due to a reduction in hose length that is made possible because the suction device 340 travels with housing 310. A further advantage is that the suction device 340 substantially prevents housing 310 from spinning about cylindrical member 313 when it is attached thereto. Another advantage concerns the cost savings associated with using a shorter hose.

Referring to FIG. 11b, according to a further embodiment, suction device 340 may be attached to housing 310 by way of a rigging system 400 that is attached to a main suspender 405 of a structure such as a bridge that includes a plurality of cylindrical members 410a, 410b attached to main suspended 405. Specifically, rigging system 400 comprises a saddle 415 attached around main suspended 405, a choker 420 attached to saddle 415 for supporting an upper pulley 425 and a cable 428 (including cable portion 428a and cable portion 428b), and a lifting and stabilizing bridle 435 attached to cable portion 428a for supporting housing 310 and suction device 340. Additionally, a lower pulley (not shown) is provided such that cable portion 428b wraps around the lower pulley and then is attached to the bottom of housing 310.

In the illustrated embodiment, bridle 435 comprises an inverted v-shaped element having a first end 440 attached to housing 310, a second end 445 attached to suction device 340 and a bent area 450 attached to housing and suction device suspender 430. Similar to the previous embodiment, the amount of negative pressure created in the housing 310 by suction device 340 is much greater since suction device 340 travels with the housing 310, thereby permitting a significant reduction in length of air hose 345. As described above, air hose 345 forms a conduit between housing 310 and suction device 340 for the removal of paint chips, waste fluid, dirt, dust and other debris from the housing. Of course, the reduction in air hose length improves the suction power of suction device 340. Additional advantages of rigging system 400 include preventing housing 310 from spinning about cylindrical member 410a and the cost savings associated with using a shorter hose.

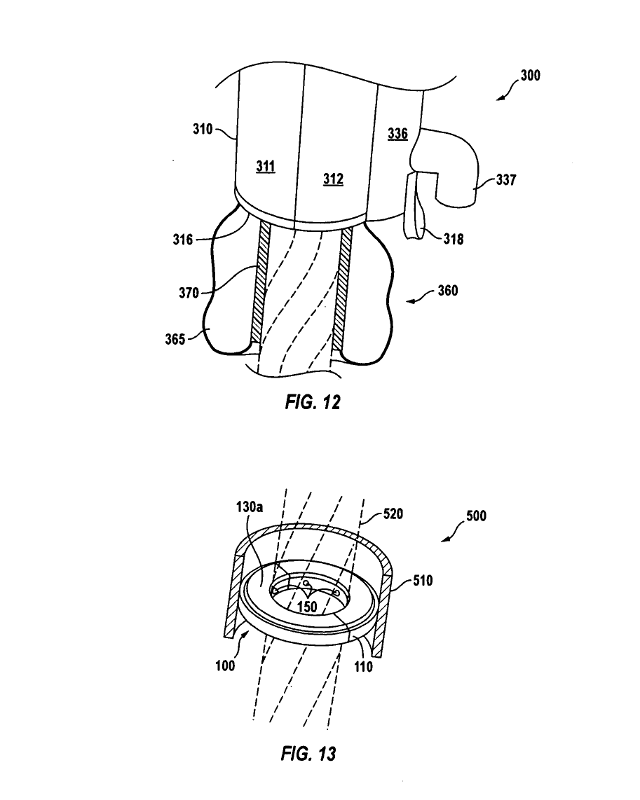

Referring to FIG. 12, according to another aspect of the invention, a pouch 360 is provided at the bottom of the housing for catching small particles of paint, dirt, dust and other debris that fall through split alignment ring 316. Such particles would otherwise be released into the environment as potential contaminants. Pouch 360 comprises a flexible outer bag 365 and an inner tube 370 that is adapted to slide along the perimeter of cylindrical member 313 as the cylindrical member maintenance device 300 is moved along the length of the cylindrical member 313 during normal operation. Pouch 360 is preferably detachable from housing 310 such that the collected particles may be properly disposed of in an environmentally sensitive manner. Suitable materials for inner tube 370 include, but are not limited to HDPE and PVC.

According to additional embodiments of the invention, one or more cutters 100 may be used in conjunction with the cylindrical member maintenance device of FIG. 1 such that cutters 100, one or more brush assemblies 21, 22, and spray nozzles 29 are disposed within a single housing 10. For these embodiments, the cutters 100 and brush assemblies 21, 22 are preferably removed during painting. Additionally, suction device 340 may be attached to the cylindrical member maintenance device (of FIG. 1) such that the suction device travels with the housing, thereby permitting air hose 345 to be significantly shorter and increasing the negative pressure within the housing during operation. Again, all of these peripheral parts can be employed with the self contained cutter embodiment of FIG. 13 as described above.

Thus, it is seen that a cylindrical member maintenance device including a cutting ring is provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

What is claimed is:

1. A maintenance device comprising at least one cutting ring positioned in a housing and rotatable about a cylindrical member passing within said housing and being coaxial therewith, said cutting ring having an annular body and central opening aligned with a cylindrical opening in said housing and further comprising a plurality of cutting elements supported by said annular body and having cutting ends extending towards said central opening such that as said cylindrical member passes through said cylindrical opening in said annular body and in said housing, said annular body rotates causing said cutting elements to engage said cylindrical member.

2. The maintenance device of claim 1 wherein said cutting ring further comprises bearing elements on opposed surfaces of said annular body to reduce friction between said annular body and housing.

3. The maintenance device of claim 1 wherein said annular body and housing are comprised of two halves, openable and closeable about said cylindrical member.

4. The maintenance device of claim 1 wherein said cutting elements are sized and positioned to engage grooves in said cylindrical member.

5. The maintenance device of claim 1 wherein said annular body further comprises a plurality of threaded openings, each threaded opening receiving a complimentary threaded set screw for establishing and maintaining said cutting ends extending toward said central opening.

6. The maintenance device of claim 1 comprising a plurality of cutting rings, each cutting ring having an annular body and central opening aligned with a cylindrical opening in said housing and further comprising a plurality of cutting elements supported by said annular bodies and having cutting ends extending towards said central opening such that as said cylindrical member passes through said cylindrical openings in said annular bodies and in said housing, said annular bodies rotate causing said cutting elements to engage said cylindrical member.

7. The maintenance device of claim 1 further comprising at least one brush assembly disposed within the housing for engaging and cleaning said cylindrical member.

8. The maintenance device of claim 7 wherein said brush assembly is positioned between a pair of cutting elements, each cutting element being independently rotatable about said cylindrical member.

9. The maintenance device of claim 8 wherein said brush assembly comprises a longitudinal brush assembly or a helical brush assembly.

10. The maintenance device of claim 1 wherein said cutting ring comprises six cutting elements, each of said cutting elements being separated from two other cutting elements by approximately 60 degrees, as measured from a mid point of said central opening.

11. A maintenance device comprising at least one cutting ring positioned in a housing and rotatable about a cylindrical member passing within said housing and being coaxial therewith, said cutting ring having an annular body and central opening aligned with a cylindrical opening in said housing and further comprising a plurality of cutting elements supported by said annular body and having cutting ends extending towards that central opening such that as said cylindrical member passes through said cylindrical opening in said annular body and in said housing, said annular body rotates causing said cutting elements to engage said cylindrical member, said housing being further characterized as having at least one aperture for connection to a suction device for removing contaminants generated within said housing, said suction device attached to the housing.

12. The maintenance device of claim 11 wherein said suction device travels with said housing as said cylindrical member passes through said cylindrical opening.

13. The maintenance device of claim 11 further comprising a distribution chamber and an air hose forming a conduit between said aperture and said suction device for the removal of paint chips, waste fluid, dirt, dust and other debris from the housing.

14. A maintenance device comprising at least one cutting ring positioned in a housing and rotatable about a cylindrical member passing within said housing and being coaxial therewith, said cutting ring having an annular body and central opening aligned with a cylindrical opening in said housing and further comprising a plurality of cutting elements supported by said annular body and having cutting ends extending towards said central opening such that as said cylindrical member passes through said cylindrical opening in said annular body and into said housing, said annular body rotates causing said cutting elements to engage said cylindrical member and a pouch attached to said housing for catching particles emanating therefrom resulting from interaction between said cutting ring and said cylindrical member.

15. The maintenance device of claim 1 wherein said cutting ring further comprises wear bearings enabling said cutting ring to rotate about said cylindrical member while reducing friction between said cutting ring and adjacent surfaces.

16. The maintenance device of 1 wherein said cutting elements comprise pins having a threaded proximal portion for engaging correspondingly threaded portions of through holes within said annular body and tapered distal ends that protrude inwardly into said central opening.

17. The maintenance device of claim 1 further comprising nozzles positioned inside of said housing for applying a material to said cylindrical member.

18. The maintenance device of claim 11 wherein said suction device is supported by a hangar assembly.
